(19) United States
(12) Patent Application Publication
(10) Pub. No.: US 2026/0247464 A1
(43) Pub. Date: Aug. 20, 2026

(54) HETEROGENEOUS NETWORK SYSTEM AND ESTABLISHMENT METHOD AND MASTER NODE DEVICE THEREOF

(71) Applicant: SENAO NETWORKS, INC., TAOYUAN (TW)

(72) Inventors: CHUNG-YEN CHIANG, TAOYUAN (TW); CHENG-TA LEE, TAOYUAN (TW)

(21) Appl. No.: 19/226,273

(22) Filed: Jun. 3, 2025

(30) Foreign Application Priority Data
Feb. 17, 2025 (TW) 114105718

(51) Int. Cl. H04W 76/15; H04W 48/16; H04W 48/18

(52) U.S. Cl. CPC H04W 76/15; H04W 48/16; H04W 48/18

(57) ABSTRACT

The present invention provides a master node device. The master node device includes an antenna and a processor. The processor is configured to: broadcast a first temporary connection parameter and a second temporary connection parameter via the antenna in response to a network connection request; establish a first temporary network connection with a first node device via a first type connection based on the first temporary connection parameter, and establish a second temporary network connection with a second node device via a second type connection based on the second temporary connection parameter; establish a node list including the first node device and the second node device; and in response to a selection command, transmit formal connection parameters to at least one selected node device in the node list.

### CROSS-REFERENCE TO RELATED APPLICATIONS

This application claims priority to Taiwan Patent Application No. 114105718 filed on Feb. 17, 2025, which is hereby incorporated by reference in its entirety.

### FIELD OF THE INVENTION

The present invention relates to a heterogeneous network system and an establishment method thereof, and a master node device applicable thereto; in particular, it relates to a method and system for simplifying the setup process and the connection of a heterogeneous network, and a master node device applicable thereto.

### BACKGROUND OF THE INVENTION

A wireless mesh network system is a network topology formed by multiple wireless nodes communicating with each other to establish connections. The network system typically consists of gateways, routers, and network clients. Each wireless node in a mesh network system contains information about other wireless nodes within the mesh network system, thereby forming the routing required for data transmission. Hence, the wireless nodes in the mesh network system are able to automatically select an appropriate path according to current network characteristics. Therefore, even if changes occur to a wireless node in the mesh network system, the transmission is not affected. Through a backbone network composed of wireless networks, users are allowed to move within the coverage area of the mesh network signal of the mesh network system and maintain data transmission in the coverage area, i.e. achieving the goal of roaming. Therefore, wireless mesh networks have the advantages of easy deployment, expansion, and intelligent transmission management.

Despite of the aforementioned advantages of wireless mesh network systems, currently, users need to set multiple network parameters or tasks to achieve the goals of establishing a wireless mesh network system and/or adding one or more nodes to an existing wireless mesh network system.

On the other hand, with the progress of technologies from various vendors, individual nodes within a wireless mesh network system may not adopt the same communication architecture. Specifically, different communication architectures may be configured to utilize different connection types which cannot communicate with each other. For such a wireless mesh network system containing nodes using different architectures (i.e., a heterogeneous network system), the number of parameters required for establishing and adding nodes is significantly increased. Users must go through more complex configurations to add or establish a heterogeneous wireless mesh network system.

Therefore, for heterogeneous network systems, a simple and fast configuration method is required.

### SUMMARY OF THE INVENTION

One objective of the present invention is to provide a master node device that can serve as a bridge between nodes of two or more different architectures.

One objective of the present invention is to provide a heterogeneous network system and a method of establishment thereof, which allows adding nodes in a heterogeneous network system by a simple authentication.

The present invention provides a master node device which includes an antenna and a processor. The processor is configured to: broadcast a first temporary connection parameter and a second temporary connection parameter via the antenna in response to a network connection request; establish a first temporary network connection with a first node device via a first type connection based on the first temporary connection parameter, and establish a second temporary network connection with a second node device via a second type connection based on the second temporary connection parameter; establish a node list including the first node device and the second node device; and in response to a selection command, transmit formal connection parameters to at least one selected node device in the node list.

In an embodiment, the processor is further configured to: communicatively connect with a user device to receive the network connection request and the selection command.

In an embodiment, the first type connection is a Wireless Distribution System (WDS), and the second type connection is an Access Point (AP)-Station (STA) link (SP-STA link).

In an embodiment, the first temporary connection parameter includes a WDS learning IE beacon and a first Simple Setting Information, and the second temporary connection parameter includes a second Simple Setting Information.

The present invention provides a heterogeneous network system which includes a first node device, a second node device and a master node device mentioned above.

The present invention provides a method for establishing a heterogeneous network which includes: broadcasting a first temporary connection parameter and a second temporary connection parameter via the antenna in response to a network connection request; establishing a first temporary network connection with a first node device via a first type connection based on the first temporary connection parameter, and establishing a second temporary network connection with a second node device via a second type connection based on the second temporary connection parameter; establishing a node list including the first node device and the second node device; and in response to a selection command, transmitting formal connection parameters to at least one selected node device in the node list.

In summary, the master node device broadcasts the first temporary connection parameter and the second temporary connection parameter through the antenna, and establishes the first temporary network connection through the first type connection and the second temporary network connection through the second type connection. Therefore, the master node device simultaneously handles two (or more) types of connection architectures. The master node device is able to serve as a bridge between two or more nodes of different architectures. Moreover, through the temporary network connections and providing the node list to users, the users are able to select the node devices listed in the node list to establish or add according to their needs, and transmit the formal connection parameters to the selected node devices. Accordingly, the users are allowed to establish a wireless mesh network system or add node device to an existing wireless mesh network system with a convenient and simplified way.

### BRIEF DESCRIPTION OF THE DRAWINGS

The accompanying drawings are presented to aid in the description of various aspects of the disclosure and are provided solely for illustration. To simplify the drawings and highlight the contents to be presented, the well-known structures or elements in the drawings may be drawn in a simple schematic manner or presented in an omitted manner. For example, the number of elements may be singular or plural. These drawings are provided only to explain such aspects and not to limit them.

FIG. 1 is a schematic diagram of the architecture of the heterogeneous network system in an embodiment of the present invention.

FIG. 2 is a flowchart of the method for establishing a heterogeneous network in an embodiment of the present invention.

FIG. 3 is a data transmission flowchart for heterogeneous network establishment in an embodiment of the present invention.

FIG. 4 is a schematic diagram of the fields of the beacon in an embodiment of the present invention.

FIG. 5 is a schematic diagram of the heterogeneous network system and beacon transmission in an embodiment of the present invention.

### DETAILED DESCRIPTION OF THE PREFERRED EMBODIMENTS

Even though terms such as “first,” second,” and “third” may be used to describe an element, a part, a region, a layer, and/or a portion in the present specification, these elements, parts, regions, layers and/or portions are not limited by such terms. Such terms differentiate an element, a part, a region, a layer, and/or a portion from another element, part, region, layer, and/or portion. Therefore, in the following discussions, a first element, portion, region, or portion may be called a second element, portion, region, layer, or portion, and do not depart from the teaching of the present disclosure. The terms “comprise,” “include,” or “have” used in the present specification are open-ended terms and mean to “include,” but not limited to

As used herein, the term “coupled to” in the various tenses of the verb “couple” may mean that element A is directly connected to element B or that other elements may be connected between elements A and B (i.e., that element A is indirectly connected with element B).

The terms “approximate” or “essentially” used in the present specification include the value itself and the average values within the acceptable range of deviation of the specific values confirmed by a person having ordinary skill in the current art, considering the specific measurement discussed and the number of errors related to such measurement (that is, the limitation of the measurement system). For example, “about” may mean within one or more standard deviations of the value itself or ±30%, ±20%, ±10%, ±5%. In addition, “about,” “approximate,” or “essentially” used in the present specification may select a more acceptable range of deviation or standard deviation based on optical property, etching property, or other properties. One cannot apply one standard deviation to all properties.

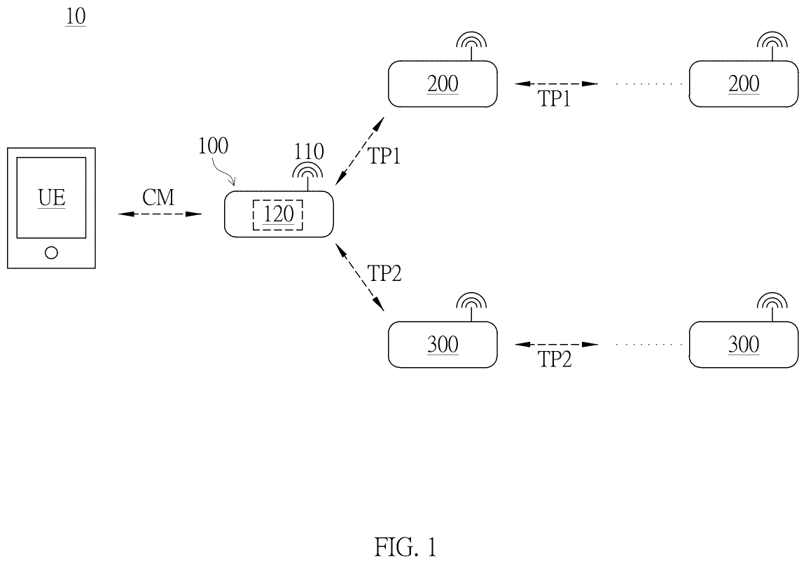

Referring to FIG. 1, FIG. 1 is a schematic diagram of the architecture of the heterogeneous network system of the present invention. As shown in FIG. 1, a heterogeneous network system 10 includes a master node device 100, a first node device 200 and a second node device 300. The master node device 100 includes an antenna 110 and a processor 120. The user equipment (UE) is communicably coupled to the master node device 100 via conventional wireless transmission technology (CM) such as Wi-Fi or Bluetooth. Users can quickly set parameters for the first node device 200 and the second node device 300 through the master node device 100. Therefore, it is possible to quickly establish a wireless mesh network or add new nodes to an existing wireless mesh network to expand the number of node devices in the wireless mesh network.

Specifically, the master node device 100, the first node device 200, and the second node device 300 are telecommunications network devices such as routers. The master node device 100, the first node device 200, and the second node device 300 are configured to connect a user equipment (UE) (such as smartphones, computers, or tablets) to other network devices, wherein the first node device 200 and the second node device 300 belong to different network architectures. For example, the connection between the master node device 100 and the first node device 200 and the connection among a plurality of the first node devices 200 belong to the first type connection (TP1) (e.g. Wireless Distribution System (WDS)). The connection between the master node device 100 and the second node device 300 and the connection among a plurality of the second node devices 300 belong to the second type connection (TP2) (e.g. Access Point (AP) to Station (STA) link (AP-STA link)). It should be noted that the first type connection (TP1) and the second type connection (TP2) mentioned above are only examples to illustrate that the first node device 200 and the second node device 300 belong to different network architectures. The connection types of the first node device 200 and the second node device 300 are not limited by the aforementioned examples. Furthermore, the present invention does not limit the number of the first node devices 200 and/or the second node devices 300. The first node device 200 and the second node device 300 can be respectively referred to as a plurality of first node devices 200 and a plurality of second node devices 300.

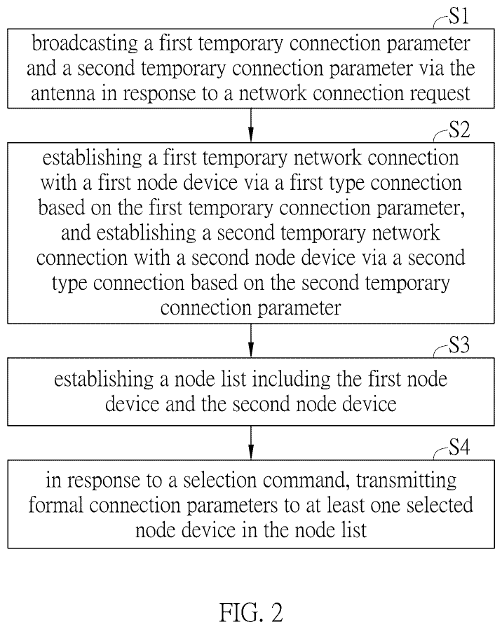

The processor 120 of the master node device 100 is configured to execute the steps of the heterogeneous network establishment method as described in FIG. 2. The method for establishing a heterogeneous network includes: (Step S1) broadcasting a first temporary connection parameter and a second temporary connection parameter via the antenna in response to a network connection request; (Step S2) establishing a first temporary network connection with a first node device via a first type connection based on the first temporary connection parameter, and establishing a second temporary network connection with a second node device via a second type connection based on the second temporary connection parameter; (Step S3) establishing a node list including the first node device and the second node device; and (Step S4) in response to a selection command, transmitting formal connection parameters to at least one selected node device in the node list.

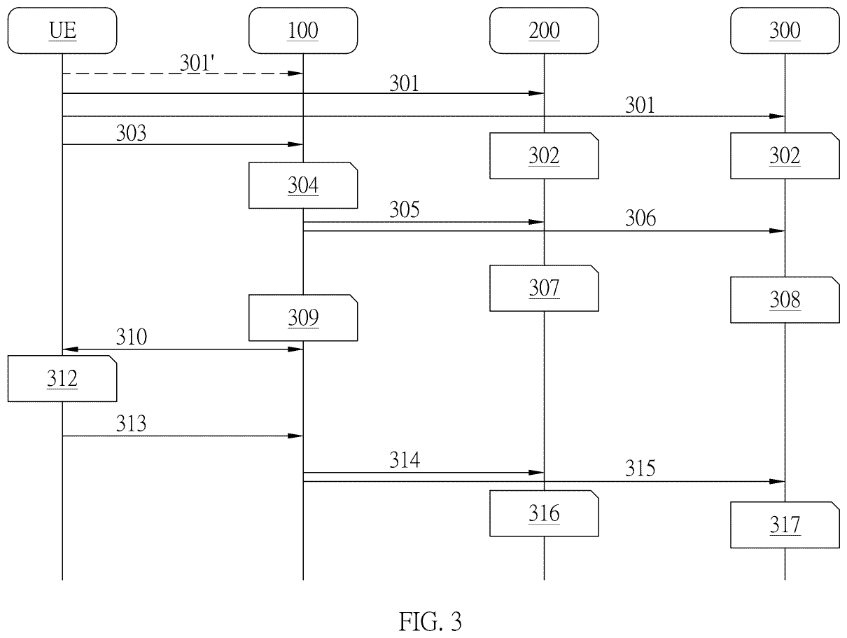

More specifically, referring to FIG. 3, FIG. 3 illustrates the data transmission flowchart. In step S1, the user can manually or through an application program (APP) on a user device (such as a smartphone or computer) provide a wake-up signal (301) to the first node device 200 and the second node device 300. In response to the wake-up signal (301), the first node device 200 and the second node device 300 enter a standby mode (or a listening mode (302)) and wait for a connection to be established. In an embodiment, the user provides an assignment signal (301′) through an application program (APP) to assign the master node device 100, and, through an application program (APP) or graphical user interface (GUI), set the connection information (such as identification code (ID), channel, password, and other connection information) of the master node device 100 and/or the heterogeneous network. For example, users may operate the menu of APPs stored in the user device to provide Connection Request (303) to the master node device 100. When the master node device 100 receives the network connection request from the user device, the master node device 100 will enter a fast setup mode (304) and broadcast a first temporary connection parameter (305) and a second temporary connection parameter (306) through the antenna of the master node device 100. The first temporary connection parameter (305) and the second temporary connection parameter (306) respectively have IE messages corresponding to the first node device 200 and the second node device 300 (e.g. WDS learning IE beacon).

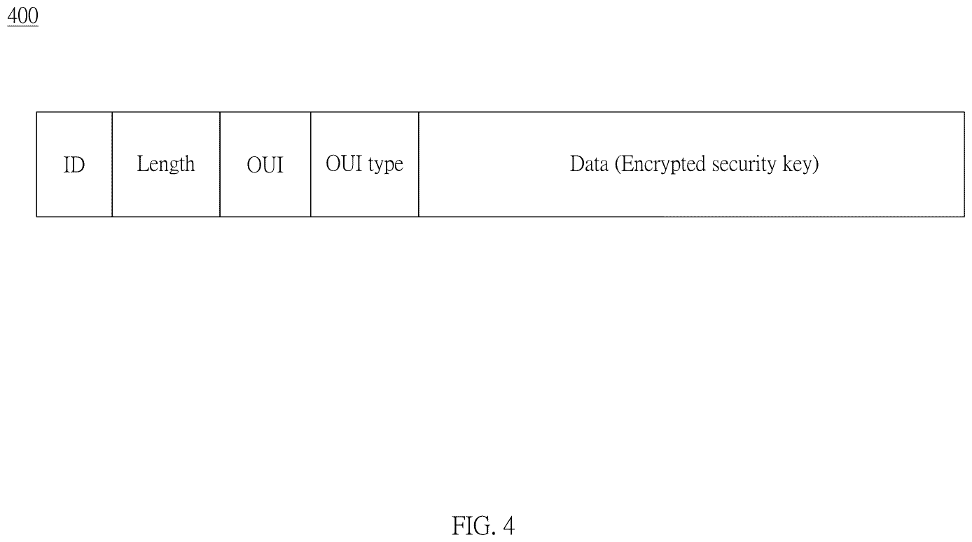

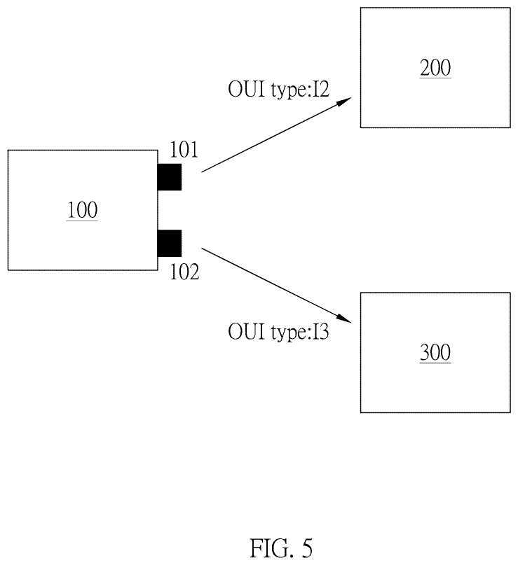

In an embodiment of step S1, referring to FIGS. 4-5, the master node device 100 may be configured to include two layer-2 transmission interfaces 101 and 102. One of the layer-2 transmission interfaces 101 and 102 (e.g. the transmission interfaces 101) corresponds to WDS and is configured to send the first temporary connection parameter, which includes the first simple setting information (SSI1). And the other interface corresponds to AP and is configured to send the second temporary connection parameter, which includes the second simple setting information (SSI2). For example, the example settings of the first and second simple setting information are shown in FIG. 4. Referring to FIG. 4, the OUI field in the beacon 400 is used to identify the manufacturer, and the OUI type field is used to define the packet type (such as the functionality of IE). The function of the OUI type field is defined by value. The value of the OUI type field can be, for example, 0x00 to 0xFF, but is not limited thereto. For example, the function definition of the OUI type field may include a first value corresponding to WDS learning IE beacon, a second value (I2) corresponding to the first simple setting information (SSI1), and a third value (I3) corresponding to the second simple setting information (SSI2). However, the value for function definition of the OUI type is not limited to these. In the embodiment shown in FIGS. 4-5, the master node device 100 transmits the first simple setting information (SSI1) and the second simple setting information (SSI2) beacons through the same network protocol. The first simple setting information (SSI1) and the second simple setting information (SSI2) are transmitted through different layer-2 interfaces. Although the first node device 200 and the second node device 300 receive all the beacons from the master node device 100, the first node device 200 and the second node device 300 respectively recognize the OUI type field of the beacon IE and interpret the beacon IE separately. For example, the first node device 200 only corresponds to the second value (I2) in the OUI type field, while the second node device 300 only corresponds to the third value (I3) in the OUI type field. In addition, the data fields (Data) of the first simple setting information (SSI1) and the second simple setting information (SSI2) can be encrypted using an encrypted security key. Although both encryption security keys of the first simple setting information (SSI1) and the second simple setting information (SSI2) can be encrypted using AES, the first node device 200 and the second node device 300 cannot decrypt each other due to the fact that the encryption keys for the first simple setting information (SSI1) and the second simple setting information (SSI2) are different.

In step S2, the first node device 200 receives the first temporary connection parameter (305) and establishes first temporary network connections (307) with the master node device 100. The second node device 300 receives the second temporary connection parameter (306) and establishes the second temporary network connections (308) with the master node device 100. In an embodiment, the first temporary network connection (307) is a temporary WDS Link, and the second temporary network connection (308) is a temporary STA Link. It should be noted that the connection types are not limited by the embodiment and the connection will be set based on the configurations of the first node device 200 and the second node device 300. Although the embodiment shown in FIG. 3 shows that the first node device 200 and the second node device 300 belong to different connection types, the first node device 200 and the second node device 300 may be configured to belong to the same connection type (e.g. AP-STA link). In addition, the embodiment is not limited to the number of the first node devices 200 and the second node devices 300 that establish temporary network connections.

In step S3, the APP or GUI installed in the user device may be configured to display the first node device 200 and the second node device 300 that have established a temporary connection with the master node device 100. Specifically, the node list (309) can be established through the master node device 100 and provided to the user device (310). On the user device, the node list is presented in the app or GUI of the user device through visualization or listing. It should be noted that the node list can also be directly created by the user device, and the present invention is not limited by the generation method of the node list.

In step S4, the user is able to select the node device (312) to join or create through the APP or GUI, and provide a selection command (313) to the master node device 100. When the master node device 100 receives the selection command, in response to the selection command, it will transmit the formal connection parameters (314, 315) to the selected node device in the node list. Therefore, the master node device 100 establishes a connection (316, 317) between the master node device 100 and the selected node device, and the mission of establishing a heterogeneous network or adding a new node can be achieved.

In one embodiment, if an unselected node device is not selected within a certain period of time, the temporary connection can be terminated and the unselected node will enter shutdown, standby, or listening mode to wait for the next establishment or addition.

In the present invention, the master node device 100 includes multiple different learning IEs in the beacon, so that the master node device 100 is able to establish an overall list after a brief/temporary connection through different types of node devices. After selecting the required node devices, the formal connection parameters can be transmitted to all selected node devices through the temporary connection from the master node device 100. In this way, the master node device 100 can simultaneously handle two (or more) types of connection architectures. Accordingly, the master node device 100 is able to serve as a bridge between two (or more) nodes of different architectures and establishes a wireless mesh network system with the two (or more) nodes. Compared to transmitting a single type of learning IE, the master node device 100 of the present invention can quickly set up two (or more) different architectures of node devices, greatly reducing the number of setup steps and time required by users to establish heterogeneous network architectures.

The foregoing disclosure is merely preferred embodiments of the present invention and is not intended to limit the claims of the present invention. Any equivalent technical variation of the present invention's description and drawings shall be within the scope of the claims of the present invention.

What is claimed is:

1. A master node device, comprising:
an antenna; and
a processor configured to:
broadcast a first temporary connection parameter and a second temporary connection parameter via the antenna in response to a network connection request;
establish a first temporary network connection with a first node device via a first type connection based on the first temporary connection parameter, and establish a second temporary network connection with a second node device via a second type connection based on the second temporary connection parameter;
establish a node list including the first node device and the second node device; and
in response to a selection command, transmit formal connection parameters to at least one selected node device in the node list.

2. The master node device of claim 1, wherein the processor is further configured to:
communicatively connect with a user device to receive the network connection request and the selection command.

3. The master node device of claim 1, wherein the first type connection is a Wireless Distribution System (WDS), and the second type connection is an Access Point (AP)-Station (STA) link (SP-STA link).

4. The master node device of claim 3, wherein the first temporary connection parameter includes WDS learning IE beacon and a first Simple Setting Information, and the second temporary connection parameter includes a second Simple Setting Information.

5. A heterogeneous network system, comprising:
a first node device;
a second node device; and
a master node device, comprising:
an antenna; and
a processor configured to:
broadcast a first temporary connection parameter and a second temporary connection parameter via the antenna in response to a network connection request;
establish a first temporary network connection with a first node device via a first type connection based on the first temporary connection parameter, and establish a second temporary network connection with a second node device via a second type connection based on the second temporary connection parameter;
establish a node list including the first node device and the second node device; and
in response to a selection command, transmit formal connection parameters to at least one selected node device in the node list.

6. The heterogeneous network system of claim 5, wherein the processor is further configured to:
communicatively connect with a user device to receive the network connection request and the selection command.

7. The heterogeneous network system of claim 5, wherein the first type connection is a Wireless Distribution System (WDS), and the second type connection is an Access Point (AP)-Station (STA) link (SP-STA link).

8. The heterogeneous network system of claim 7, wherein the first temporary connection parameter includes WDS learning IE beacon and a first Simple Setting Information, and the second temporary connection parameter includes a second Simple Setting Information.

9. A method for establishing a heterogeneous network, comprising:
broadcasting a first temporary connection parameter and a second temporary connection parameter via the antenna in response to a network connection request;
establishing a first temporary network connection with a first node device via a first type connection based on the first temporary connection parameter, and establish a second temporary network connection with a second node device via a second type connection based on the second temporary connection parameter;
establishing a node list including the first node device and the second node device; and
in response to a selection command, transmitting formal connection parameters to at least one selected node device in the node list.

10. The method of claim 9, further comprising:
establishing a communication connection with a user device;
receiving the network connection request from the user device; and
receiving the selection command from the user device.

11. The method of claim 9, wherein the first type connection is a Wireless Distribution System (WDS), and the second type connection is an Access Point (AP)-Station (STA) link (SP-STA link).

12. The method of claim 11, wherein the first temporary connection parameter includes WDS learning IE beacon and a first Simple Setting Information, and the second temporary connection parameter includes a second Simple Setting Information.
